(19) United States
(12) Patent Application Publication
(10) Pub. No.: US 2026/0175682 A1
(43) Pub. Date: Jun. 25, 2026

(54) Projection Display Device Having a Cover Plate for Suppressing Reflections

(71) Applicant: Bayerische Motoren Werke Aktiengesellschaft, Muenchen (DE)

(72) Inventors: Michael Arthur JANZER, Unterschleissheim (DE); Martin PINSKER, Bruckberg (DE)

(21) Appl. No.: 19/126,290

(22) PCT Filed: Oct. 17, 2023
(86) PCT No.: PCT/EP2023/078793

§ 371 Date: May 1, 2025

(30) Foreign Application Priority Data
Nov. 14, 2022 (DE) 10 2022 129 985.6

(51) Int. Cl. B60K 35/00; B60K 35/60; G02B 27/01

(52) U.S. Cl. CPC B60K 35/00; B60K 35/60; G02B 27/0101; B60K 2360/334

(57) ABSTRACT

A projection display device for a motor vehicle includes a projection device which is designed to emit image-bearing projection light for projecting a projection image into an eye region of a vehicle occupant, a transparent cover plate for protecting the projection device, and an optical system, which is designed to focus the image-bearing projection light into the eye region in such a way that the projection image is perceptible in the eye region of the vehicle occupant. The transparent cover plate has microstructuring on an outwardly directed top face, which microstructuring has mutually adjacent optical microstructure elements as a surface profile for reflecting incident ambient light in a diffusely scattered manner or predominantly into a region outside the eye region. The microstructure elements of the microstructuring have, in each case, at least in a surface direction, a randomly varying surface shape and/or surface size.

### BACKGROUND AND SUMMARY

The invention relates to projection display devices, in particular head-up display devices, for motor vehicles. In particular, the present invention relates to measures for suppressing interfering reflections of incident ambient light on a cover plate of the projection display device.

Projection display devices, such as head-up displays, for the visual display of information in the field of view of a driver of a motor vehicle are known from the prior art. For example, document DE 10 2010 032 998 A1 describes a head-up display for a motor vehicle having a projection device, via which an image to be displayed is projected through a cover plate onto a windshield of a motor vehicle acting as a combining device. Such projection display devices have the advantage in contrast to the other display devices in the motor vehicle that the driver does not have to look away from the traffic events to acquire important information, such as the current vehicle speed or visual instructions of a navigation system.

A projection display device generally has a cover plate, which protects the projection device from soiling or mechanical damage. The cover plate is transparent and can reflect ambient light depending on the angle of incidence thereof. At certain angles of incidence, ambient light, in particular directly incident sunlight, can thus be reflected into an eye area of a vehicle occupant and thus blind them.

In known projection display devices, measures are accordingly provided to avoid ambient light which is incident on a cover plate of a projection device of the projection display devices from being incident in the eye area of the vehicle occupant of the motor vehicle directly or reflected via the windshield and blinding them and/or impairing the representation and/or perception of the information to be displayed. The projection device therefore generally contains a reflective and curved cover plate which reflects incident ambient light in the direction of a light-absorbing surface, also called a mirror bench. The reflected ambient light is only reflected to a minor extent and exclusively diffusely on the light-absorbing surface, so that interfering reflections of ambient light or illumination in a display area on the windshield can be essentially avoided.

Projection display devices are typically inserted into an upper side of an instrument panel in the area above the steering column, where in general only limited installation space is available. In general, the assembly made up of the light-absorbing surface and the reflective curved cover plate has a structural height between 5 and 10 cm, however, which substantially increases the overall structural height of the projection display device. A reduction of the structural height of this assembly can only be achieved to a limited extent, since a greater height of the light-absorbing surface is required with a flatter, i.e. less curved, cover plate.

An arrangement for reflection reduction for a projection display device for a motor vehicle is known from document DE 10 2014 214 510 A1, which comprises a transparent cover plate for protecting a projection device and a shield grating having one or more flat grating elements, arranged perpendicularly or inclined in relation to a surface of the cover plate, of a grating structure.

It is therefore the object of the present invention to provide a projection display device having lower structural height, with which interfering reflections due to incident ambient light are reduced.

This object is achieved by a projection display device for a motor vehicle having a cover plate for reflection suppression according to the independent claim(s). Further embodiments are specified in the dependent claims.

According to a first aspect, a projection display device for a motor vehicle is provided, comprising:
a projection device, which is designed to output image-bearing projection light to project a projection image into an eye area of a vehicle occupant,
a transparent cover plate for protecting the projection device,
an optical unit designed to focus the image-bearing projection light in the eye area so that the projection image is perceptible in the eye area of the vehicle occupant,
wherein the transparent cover plate has a microstructuring having adjoining optical microstructure elements as a surface profile on an outwardly directed upper side, in order to reflect incident ambient light diffusely scattered or predominantly in an area outside the eye area, wherein the microstructure elements of the microstructuring each have a randomly varying surface shape and/or surface size at least along a surface direction.

Furthermore, a lower side opposite to the upper side can have a microstructuring which is formed complementary to the microstructuring of the upper side so that the projection light is transmitted and a fixed assignment of an angle of incidence of the projection light on the lower side to a specific angle of reflection on the upper side is achieved.

Furthermore, the microstructure elements of the upper side and the lower side can each have a concave or convex surface, in particular a spherically concave or convex or triangular surface.

The surface of the upper side of the cover plate can be formed substantially planar or curved along a surface direction, in particular concavely curved, over its extension, notwithstanding the microstructuring.

One aspect of the above projection display device is to provide a transparent cover plate for a projection device which has a microstructuring. The microstructuring has optical microstructure elements adjoining one another, which have an outwardly directed upper side (facing toward the windshield) having, for example, concave or convex formation. The microstructuring is used to achieve a diffuse reflection of ambient light or predominantly a reflection of ambient light in an area outside the eye area, for example of a proportion of greater than 80% or greater than 90% of the ambient light. In the diffuse reflection, incident ambient light or directly incident sunlight is diffusely scattered so that only a small proportion reaches the eye area of a vehicle occupant.

Furthermore, the microstructuring can be designed to reflect incident ambient light into an area or an absorption surface so that the proportion of ambient light incident in the eye area of a vehicle occupant can be significantly reduced, in particular by more than 80%, more than 90%, or more than 99%.

Moreover, in contrast to solutions of the prior art, the cover plate can be formed planar or flat, so that the structural height of the projection display device is reduced and the cover plate can be integrated well on the upper side of the instrument panel in a motor vehicle.

The cover plate is preferably designed so that the angle of incidence of a light beam bundle of the projection light incident from a lower side of the cover plate is maintained during a transmission through the cover plate, so that the cover plate does not influence the direction and focusing of the image-bearing projection light emitted by the projection device and an undistorted depiction is possible in the eye of the vehicle occupant or driver.

The outwardly directed surfaces (upper sides) of the microstructure elements have a microstructuring, which is characterized by concave or convex structures. To ensure the optical property of the transmission of projection light which is uninfluenced (with respect to the angle of incidence), the corresponding opposite surface of the cover plate (lower side, the surface facing toward the projection device) has concave or convex structures, so that a flat arrangement of microstructures is achieved. The usage of achromatic lenses is also possible.

To be able to perceive a projection image which is as undistorted and free of artifacts as possible, the microstructure elements can be provided in a size of, for example, 0.05 mm to 0.5 mm, possibly up to 1 mm, which precludes a perception of the interfaces between the microstructure elements due to the limited resolution of the eyes of the vehicle occupant.

However, such cover plates can result in rainbow-like artifacts due to diffraction effects in the case of periodic arrangement of the microstructure elements in a regular field arrangement. In this regard, the above-described cover plate for the projection device provides resolving the periodicity of the arrangement of the microstructure elements of the cover plate at least in one of the surface directions at least within a predetermined surface area of predetermined minimum size and forming adjacent optical microstructure elements having randomly different surface shapes and surface sizes. A periodicity is thus to be precluded within the surface area, which can result in the display of artifacts and diffraction patterns due to amplification of light diffraction.

Irregularly shaped microstructure elements are preferably retained in such an arrangement to form the microstructure elements adjoining one another. The base areas of the microstructure elements can be designed here as triangular, rectangular, pentagonal, and hexagonal.

It can be provided that in the surface area, the microstructure elements of the microstructuring each have a random surface shape and/or surface size, wherein the entire surface of the cover plate is formed by surface areas adjoining one another, which are in particular identical, wherein in particular the surface area has a size of 20 mm² to 150 mm².

In particular, the microstructuring of the cover plate can be designed so that within a predetermined surface area of at least 3 mm, at least 4 mm, or at least 5 mm edge length, the arrangement of the individual microstructure elements does not repeat in its size and shape. These surface areas can then be arranged as tiles to form the entire cover plate.

The arrangement of the microstructure elements necessarily results in diffraction patterns, which are generated by each interface between adjacent microstructure elements. While such diffraction patterns are amplified with a periodic/regular arrangement of microstructure elements and are thus perceptible, due to the irregular arrangement of the microstructure elements, only the zeroth orders of the transmitted useful light are superimposed, whereas the diffraction patterns of all other orders of diffraction are distributed over an angle range, the width of which depends on the distribution of the surface sizes of the individual microstructure elements. This substantially reduces the perceptibility of superimposed diffractions of non-zeroth orders of diffraction.

The microstructure elements can each have a spheric, aspheric, or free-form convex or concave structure to thus enable the best possible scattering of the incident ambient light upon its reflection on the surface of the cover plate.

To maximize the quality of the transmission of the projection light, it can be provided that the microstructuring of the upper side and the lower side are designed as offset in relation to one another in the plane of the cover plate. The translation vector is then selected so that it is ensured that a projection light beam bundle (projection light), which is coupled into the center of one of the microstructure elements of the microstructuring of the lower side, is also decoupled at the center from the corresponding microstructure element of the microstructuring of the upper side of the cover plate.

Furthermore, the profiled formation of the microstructure elements on the upper side can have a transmission surface, which is in particular planar, and an absorption surface, which are inclined in relation to one another, wherein the transmission surface is designed to transmit projection light and depending on an angle of incidence of ambient light, it is reflected on the absorption surface. The surfaces of the microstructure elements can thus have an array of triangular contours in cross section, so that a sawtooth-like surface is formed.

Furthermore, the surfaces of the microstructure elements can also in cross section have a triangular contour having transmission surfaces curved on the upper side in the cross-sectional plane, wherein each of the microstructure elements has a curved transmission surface, which can be inclined with respect to the incident ambient light so that the reflection of incident light beam bundles within an ambient light angle range is incident on an adjacent absorption surface. The transmission surface and the absorption surface are inclined in relation to one another and in cross section form a triangular or quasi-triangular (since there are curved courses with respect to the cross-sectional surface) trench or a sawtooth-like course. The transmission surface can be curved opposite to the direction of the absorption surface, i.e. concavely, on the upper side of the cover plate. On the lower side, the corresponding surface can accordingly be convexly curved in order to obtain the conformance of the transmitted projection light.

The transmission surface is used to transmit the projection light and is aligned with respect to the ambient light angle range so that any reflections cannot reach the eye area of the driver under any circumstances, i.e. are either absorbed on the absorption surface or—also possibly after reflection on the windshield—are guided past the eye area.

The absorption surface is used as a so-called glare trap, so that incident ambient light which is incident on the transmission surface and is reflected there is preferably reflected in the direction of the absorption surface/glare trap and is absorbed there. For this purpose, the absorption surface can be formed as nonreflective using a black paint or the like or a diffusely scattering surface structure.

The microstructure having triangular cross section or quasi-triangular cross section having a curved transmission surface can repeat along a surface direction of the cover plate (transversely to the extension of the transmission surfaces and absorption surfaces) with random structure widths in the arrangement direction. The cover plate can be (macroscopically) flat or curved with respect to the arrangement direction. To avoid diffraction effects, the structure width of the microstructure elements can be varied along the arrangement direction analogously to the above-described lens structures.

To achieve undistorted transmission of the useful light, the structure of the upper side of the microstructure elements is formed accordingly on the lower side of the cover plate, so that the transmission surface is opposite to a correspondingly surface-parallel surface of the lower side.

In all embodiments, the transmission surfaces on the lower side of the cover plate can be embodied at an angle to the transmission surfaces on the upper side of the cover plate in order to achieve a beam deflection or also-in the case of angles of incidence of the projection light varying along the arrangement direction-beam bundling, which is compensated for in the further optical unit.

Furthermore, a nontransparent aperture device having aperture openings can be arranged in the cover plate, so that an aperture opening is assigned to each of the microstructure elements provided with a convex, in particular spherical surface, in order to enable an angle-selective transmission through the cover plate.

The aperture element can preferably have a color which corresponds to the surroundings of the cover plate in order to thus enable visually appealing embedding of the cover plate on the surface of the instrument panel.

According to a further aspect, a motor vehicle is provided, comprising:
an instrument panel between a windshield of the motor vehicle and a steering column;
the above projection display device, which is arranged substantially flush with the upper side of the instrument panel.

Embodiments are explained in more detail hereinafter on the basis of the appended drawings. In the figures:

### BRIEF DESCRIPTION OF THE DRAWINGS

FIG. 1 is a schematic cross-sectional view through a projection display device for a motor vehicle;

FIG. 2 is a cross-sectional view through a cover plate having a non-periodic microstructuring;

FIG. 3 is a top view of the cover plate having an exemplary microstructuring of FIG. 2;

FIG. 4 is a cross-sectional view through a cover plate according to a further embodiment having an aperture device;

FIG. 5 is a cross-sectional view through a cover plate having a microstructuring having microstructure elements having a triangular cross section; and

FIG. 6 is a cross-sectional view through a cover plate having a microstructuring having microstructure elements having a quasi-triangular cross section and transmission surfaces having concave upper sides and convex lower sides.

### DETAILED DESCRIPTION OF THE DRAWINGS

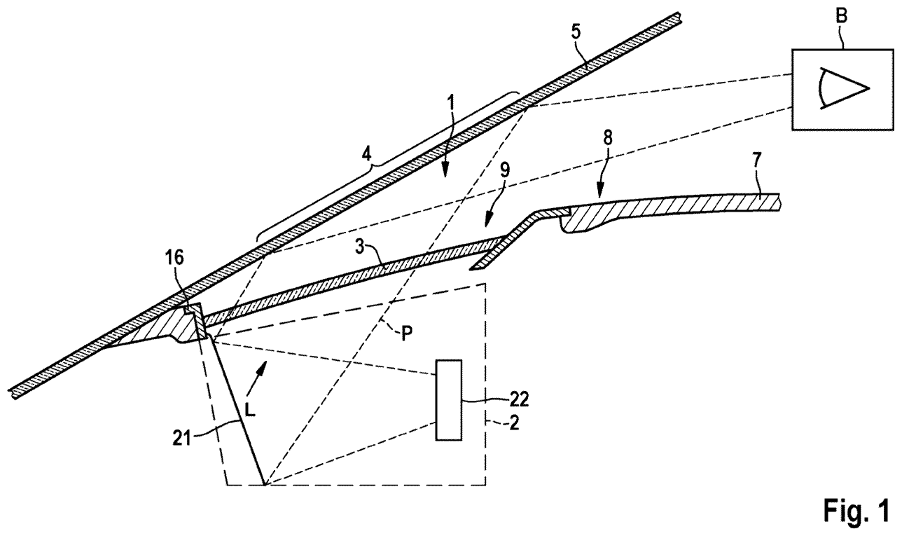

FIG. 1 schematically shows a cross-sectional view through a projection display device 1, such as a head-up display. The projection display device 1 comprises an optical projection device 2 and a cover having a cover plate 3.

The projection display device 1 is essentially inserted into an opening 9 in an upper side 8 of an instrument panel 7 between a steering wheel and a windshield 5 so that it terminates essentially with the upper side 8 or adjoins it.

The projection device 2 outputs a projection beam bundle L in a suitable manner, which is directed in a projection direction P onto a display area 4 (for example, combiner) of a windshield 5 of a motor vehicle. The projection device 2 comprises, in a known manner, a system made up of one or more mirrors 21, possibly lenses (not shown), and a projector 22. A projection image output by the projector 22 is oriented as a projection beam bundle L by the one or more mirrors 21 in the projection direction P and projected onto the display area 4. The projection light projected on the display area 4 is reflected at the display area 4 and directed onto an eye area B of a vehicle occupant, so that a projection image results in the eye of the vehicle occupant, by which information can be displayed.

While a cover plate 3 having a curvature is typically formed between the projection device 2 and the display area 4 in order to direct incident ambient light onto a light-absorbing surface arranged at the edge, a cover plate 3 is now provided directly at the projection device 2, which protects the projection device 2 from soiling due to dust particles, for example. The cover plate 3 can be formed substantially flat. However, arbitrary curved shapes of the cover plate 3 are also contemplated.

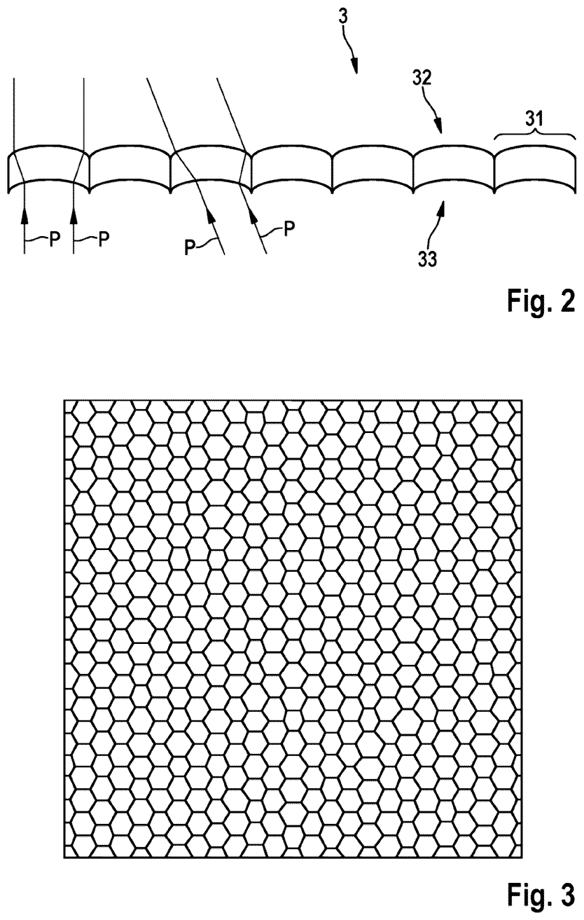

As shown by way of example in the cross-sectional view of FIG. 2, the cover plate 3 is provided on an outwardly directed upper side 32 (i.e. in the direction of the incident ambient light) with a microstructuring, which has optical microstructure elements 31 adjoining one another. The microstructure elements 31 are designed so that they transmit the projection light P retaining the angle, in particular undistorted. However, they have a profiled surface in this case, which can in particular have a convex shape as shown in FIG. 2 in order to diffusely reflect and scatter ambient light incident from the outside in a large angle range.

Due to the planar arrangement of such microstructure elements 31, incident ambient light can therefore be diffusely scattered and therefore the proportion of the reflected ambient light incident in an eye area of a vehicle occupant on the upper side 32 can be reduced. The design of the optical microstructure elements 32 so that transmitted useful light is transmitted retaining the angle, and therefore has the same angle of incidence as the angle of reflection, enables an undistorted display of a depiction of the projection image by the projection display device 1.

The cross-sectional view of FIG. 2 through the cover plate 3 shows an arrangement of microstructure elements 31 having a convex shaping of the outwardly directed upper side 32 of the cover plate 3. To ensure the undistorted transmission of the projection light P, the convex structures can be opposite to corresponding concave structures on a lower side 33 of the microstructure elements 3 opposite to the upper side.

The convex structures on the upper side can also be opposite to corresponding convex structures on the lower side, so that each of the microstructure elements 3 is used as a converging lens, wherein the angle retention is achieved. This can be achieved using a convex-convex arrangement if the thickness of the convex microstructure elements is selected so that the distance between upper side and lower side corresponds to twice the focal length.

FIG. 3 shows a possible arrangement of the microstructure elements 31 on the basis of a top view of the cover plate 3.

Since a periodic arrangement of microstructure elements 31 results in pronounced diffraction patterns perceptible due to color patterns because of mutually amplifying diffraction effects, in the cover plate 3 in this embodiment of FIGS. 2 and 3, an arrangement of the microstructure elements 31 having different surface sizes and surface shapes in a hexagonal pattern is provided. The hexagonal pattern is composed of individual microstructure elements 31 of different shapes and sizes. Alternatively, the basic structure of the microstructure elements can be rectangular, hexagonal, and/or have another polygonal basic shape, which enables a continuous arrangement in a matrix or field arrangement, i.e. enables microstructure elements 31 of randomly different shapes and sizes to be joined to one another.

In particular, the microstructuring of the cover plate 3 is provided so that the arrangement of the microstructure elements 31 takes place nonperiodically or with random shapes and sizes, i.e. does not have a regular arrangement pattern. This nonperiodicity is either maintained over the entire surface area of the cover plate 3 or is at least observed in a predetermined surface area of, for example, between 5 mm and 10 mm edge length, in order to thus reliably avoid an additive superposition of diffraction effects of higher orders of diffraction generated by individual microstructure elements 31. Due to the nonperiodic arrangement of the microstructure elements 31, a superposition of diffraction effects of higher orders of diffraction therefore results in an irregular manner, so that no amplification of the diffraction effects occurs and the perceptibility of the resulting diffraction patterns is significantly reduced.

The microstructuring of the surface of the cover plate has microstructure elements in a size which results in a resolution less than the resolution of the eye of the vehicle occupant. However, the size of the microstructure elements 31 is to be multiple times greater than the wavelength of the visible light in order to avoid additional diffraction effects due to the interfaces at which the microstructure elements 31 adjoin one another.

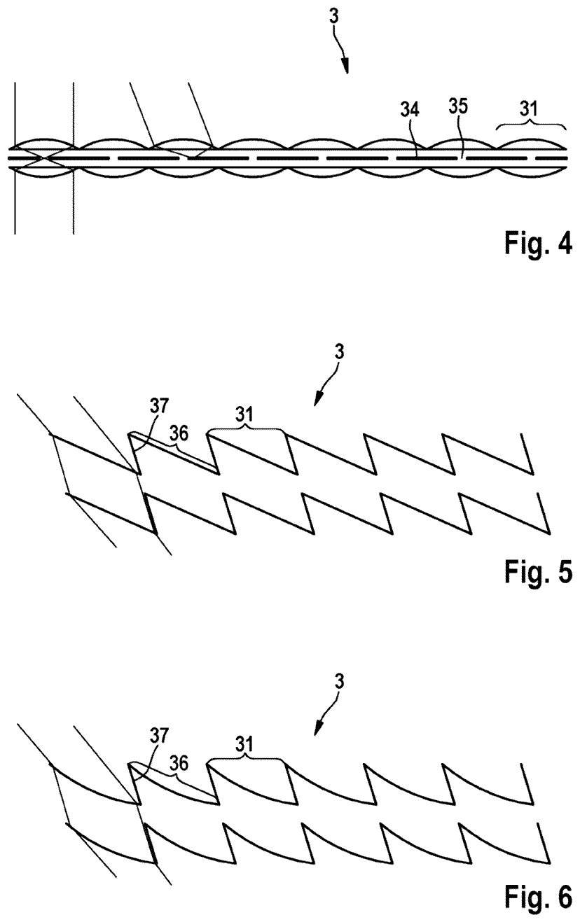

In FIG. 4, a further embodiment of a cover plate 3 having an integrated aperture device 34 is provided. For this purpose, the microstructure elements 31 are formed as individual converging lenses having convex spherical shape on the upper side and lower side, in each of which an aperture opening 35 of the aperture device 34 is arranged. The aperture openings 35 are positioned so that only light which is incident from a specific angle range on the relevant microstructure element 31 is transmitted and other angle ranges, for example preferably the angle range of the direct view of vehicle occupants on the upper side of the cover plate 3, are directed onto the aperture device 34 and are thus prevented from a transmission.

FIG. 5 shows a cross section through a cover plate 3 according to a further embodiment, wherein the microstructure elements 31 on the upper side and lower side of the cover plate 3 each have a triangular cross section along an arrangement direction. The microstructure elements 31 are characterized here by a transmission area 36, through which the projection light can be transmitted without a distortion of the display image occurring. An absorption surface 37 facing toward the transmission area 36 has an angle of approximately 10° to 50° with respect to the surface normal of the cover plate 3 and can preferably be designed as a glare trap, i.e. have a coating or surface structure which absorbs or diffusely scatters light as much as possible and prevents a reflection or coupling of light into the cover plate 3.

In the arrangement direction, the transmission area 36 and the absorption area 37 are arranged alternately with their width directions. The widths of the transmission area 36 and the adjoining absorption area 37 are selected to be sufficiently small here that a perceptibility of the microstructuring thus formed in the eye area is precluded, for example between 0.1-1 mm. In a surface direction transverse to the arrangement direction, the transmission areas 36 and absorption areas 37 can extend up to over the entire width of the cover plate 3. Ambient light from a specific angle range, which is reflected on a surface of the transmission area 36 of a microstructure element 31, can therefore preferably be reflected in the direction of the absorption surface 37 and either absorbed or diffusely reflected there, in order to avoid further reflections of the reflected ambient light.

As shown in FIG. 6, instead of the triangular cross section, the transmission areas 36 of the microstructure elements 31 of the upper side can also be concavely curved with respect to the arrangement direction, in order to enlarge the angle range from which incident ambient light is directed onto the absorption area 37. Accordingly, the transmission areas on the lower side of the cover plate 3 can be convexly curved accordingly in the arrangement direction.

List of reference signs

| | |
|---|---|
| 1 | projection display device |
| 2 | projection device |
| 21 | projection mirror |
| 22 | projector |
| 3 | cover plate |
| 31 | microstructure element |
| 32 | upper side |
| 33 | lower side |
| 34 | aperture device |
| 35 | aperture opening |
| 36 | transmission surface |
| 37 | absorption surface |
| 4 | display area |
| 5 | windshield |
| 7 | instrument panel |
| 8 | upper side |
| 9 | opening |
| L | projection beam bundle |
| P | projection direction |

1.-11. (canceled)

12. A projection display device for a motor vehicle, comprising:
a projection device configured to output image-bearing projection light for projecting a projection image into an eye area of a vehicle occupant;
a transparent cover plate to protect the projection device;
an optical unit designed to focus the image-bearing projection light into the eye area so that the projection image is perceptible in the eye area of the vehicle occupant,
wherein the transparent cover plate has a microstructuring having adjoining optical microstructure elements as a surface profile on an outwardly directed upper side, in order to reflect incident ambient light diffusely scattered or predominantly into an area outside the eye area, and
wherein the microstructure elements of the microstructuring each have a randomly varying surface shape and/or surface size at least along a surface direction.

13. The projection display device according to claim 12, wherein
a lower side, opposite to the upper side, has a microstructuring which is formed complementary to the microstructuring of the upper side of the cover plate so that, for each microstructure element, the projection light is transmitted and a fixed assignment of an angle of incidence of the projection light on the lower side to a specific angle of reflection on the upper side is achieved.

14. The projection display device according to claim 12, wherein
the microstructure elements each have a concave or convex surface on their upper side and their lower side.

15. The projection display device according to claim 14, wherein
the microstructure elements each have the concave or convex surface on their upper side and their lower side in the form of a spheric, aspheric, or free-form convex or concave or triangular surface.

16. The projection display device according to claim 12, wherein
the upper side of the cover plate has a surface that is planar or curved along a surface direction.

17. The projection display device according to claim 16, wherein
the surface is concavely curved along the surface direction.

18. The projection display device according to claim 12, wherein
in one surface area, the microstructure elements of the microstructuring each have a random surface shape and/or surface size along at least one surface direction, and
an entire surface of the cover plate is formed by adjoining surface areas, wherein the adjoining surface areas each have a size of 20 mm² to 150 mm².

19. The projection display device according to claim 12, wherein
base areas of the microstructure elements of the microstructuring are each formed triangular, rectangular, pentagonal, or hexagonal.

20. The projection display device according to claim 12, wherein
an absolute value of the angle of incidence corresponds to the absolute value of the angle of reflection, or
an assignment of the angle of incidence of the projection light on the lower side to the angle of reflection on the upper side effectuates the optical property of a prism, a converging lens, or a diffusion lens.

21. The projection display device according to claim 17, wherein
formation of the microstructure elements on the upper side of the cover plate has a transmission surface, which is planar or concavely curved, and an absorption surface angled in relation thereto away from the cover plate, and
the transmission surface is configured to transmit the projection light and, depending on an angle of incidence range of ambient light, reflects the ambient light onto the absorption surface.

22. The projection display device according to claim 21, wherein
the lower side of the cover plate has surface sections which are opposite to the transmission surfaces with respect to a surface normal or a direction inclined thereto so that a beam of the projection light, which enters in each case through a center of a microstructure element on the lower side of the cover plate emerges through the center of the corresponding microstructure element on the upper side of the cover plate.

23. The projection display device according to claim 12, further comprising:
a nontransparent aperture device having aperture openings arranged in the cover plate so that an aperture opening is assigned to each of the microstructure elements provided with a convex surface, in order to enable an angle-selective transmission through the cover plate.

24. A motor vehicle, comprising:
the projection display device according to claim 12;
an instrument panel between a windshield of the motor vehicle and a steering column,
wherein the projection display device is arranged substantially flush with an upper side of the instrument panel.
